(19) United States
(12) Patent Application Publication
(10) Pub. No.: US 2009/0117878 A1
(43) Pub. Date: May 7, 2009

(54) Multimedia data format conversion and transfer

(76) Inventor: Arnaud Rosay, Voivres Les Le Mans (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(21) Appl. No.: 11/630,548

(22) PCT Filed: Jun. 20, 2005
(86) PCT No.: PCT/IB05/52012

§ 371 Date: Nov. 13, 2008

(30) Foreign Application Priority Data
Jun. 21, 2006 (EP) 04300388.8

(51) Int. Cl. H04L 12/58; H04M 1/00

(52) U.S. Cl. 455/412.1; 455/556.1

(57) ABSTRACT

The telecommunication device (2) is configured to exchange multimedia related data through a data link (6) between the telecommunication device (2) and a destination device (4) adapted to process the data. It comprises—an extracting module (20) configured to extract an embedded multimedia element from a multimedia messaging service (MMS) message, the embedded multimedia element comprising a file format; and—a file format changer (22) configured to change the file format of the embedded multimedia information into an adapted file format to be transmitted to the destination device. In particular, the telecommunication device can be applied to a mobile phone environment.

### FIELD OF THE INVENTION

The present invention relates to multimedia data format conversion and transfer.

### BACKGROUND OF THE INVENTION

Today, mobile handsets or phones are capable of supporting multimedia rich features such as text, images, video and sound files. A standard called the Multimedia Messaging Service (MMS), as its name suggests, enables MMS capable handsets to send and receive messages having a combination of multimedia rich features.

The MMS standard defines the possible contents of an MMS message. An MMS message is organised as a slide set, and each slide called a multipart can contain up to three different types of files: text, image and sound. The aim of the MMS standard is to ensure the interoperability and exchangeability of multimedia messages.

For instance, when multimedia files are exchanged between devices, the multimedia contents of a received message are detached and stored in the mobile phone. Accordingly, image attachments are stored in one of the supported formats such as JPEG and sound attachments can be stored in an AMR file format. However, current mobile phone applications do not support ready exchange of multimedia files as such with other devices as easily as is done with the exchange of multimedia files between a digital camera device and a personal computer, for example.

Therefore, it is desirable to facilitate the exchange of multimedia files between mobile handsets or phones and their destination devices.

### SUMMARY OF THE INVENTION

Accordingly, it is an object of the invention to provide full digital camera functionalities to mobile phones.

The invention provides a telecommunication device configured to exchange multimedia related data through a data link between the telecommunication device and a destination device adapted to process the data, wherein the telecommunication device includes an extracting module configured to extract an embedded multimedia element from a multimedia messaging service (MMS) message, the embedded multimedia element comprising a file format, and a file format changer configured to change the file format of the embedded multimedia information into an adapted file format to be transmitted to the destination device.

In this invention, the file format of the embedded multimedia information is changed and converted into an adapted file format. Thus, the exchange of multimedia files between mobile handsets or phones and their destination devices is greatly facilitated.

The device features as defined in claim 2 improve the exchange of image files.

The device features as recited in claim 3 have the advantages of improving the exchange of print files.

Other features of the device for exchanging multimedia related data are recited in the dependent claims.

The invention also relates to a method for exchanging multimedia related data according to claim 12.

These and other aspects of the device for exchanging multimedia related data will be apparent from the following description, drawings and from the claims.

### BRIEF DESCRIPTION OF THE DRAWINGS

FIG. 1 is a schematic diagram of a mobile phone in a system for exchanging multimedia related data according to the invention; and

FIG. 2 is a flowchart of a method for exchanging multimedia related data taking place in the system as shown in FIG. 1.

### DESCRIPTION OF THE PREFERRED EMBODIMENTS

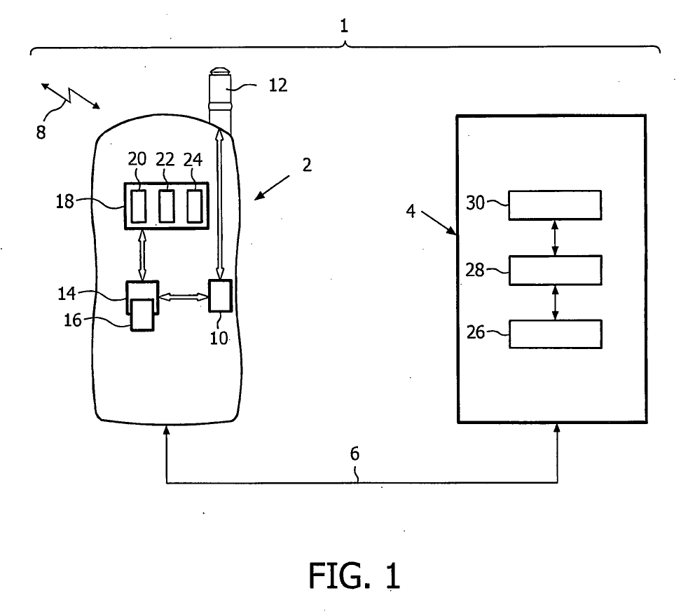

Referring to FIG. 1, a multimedia data exchange system 1 includes a mobile phone 2 connected to a personal computer 4. A physical data link 6 connects the mobile phone 2 and the personal computer 4.

The personal computer 4 is configured to implement an application that retrieves the image from a digital camera. This application uses a specific format, namely, the EXIF (Exchangeable Image File Format). The EXIF format is neither standardized nor compliant with MMS messages. EXIF is a standard for storing interchange information in image files, especially those using JPEG (Joint Photographic Experts Group) compression. Generally, most digital cameras now use the EXIF format because of interoperability between imaging devices.

The mobile phone 2 is adapted to receive or transmit radio data communication such as an MMS message 8. A transmitter/receiver 10 in the mobile phone 2 plays the role of a communication control for effecting radio communication using any given communication protocol to receive the message 8. The transmitter/receiver 10 carries out the communication via an antenna 12. The transmitter/receiver 10 is adapted to send/receive multimedia rich files and in particular, messages containing image, sound, and/or text. Applications exchanging image, sound, and/or text utilize MMS messages that support JPEG, GIF (Graphic Interchange Format), and WMBP (Wireless BitMaP) formats. For sound data files, an AMR (Adaptive Multiple Rate) format is supported.

The mobile phone 2 includes a card slot 14 from which a memory card 16 is removably connected. The card slot 14 and the memory card 16 are connected to the transmitter/receiver 10.

The mobile phone 2 also includes a controller 18. The controller 18 is a central processing unit implemented as a microcomputer system having a microprocessor which defines the data exchange procedures of the mobile phone 2. That is, the controller 18 includes an exchanging module 20, a file format changing module 22, and a detecting module 24.

The exchanging module 20 is adapted to extract an embedded multimedia element (e.g., image file) from the incoming MMS message 8. The image file, for example, has a particular by designated file format.

The file format changing module 22 is adapted to convert the file format into an EXIF format of the multimedia information extracted by the exchanging module 22 and which is intended to be transmitted to the personal computer 4.

Further, the detecting module 24 is adapted to automatically detect the physical data link 6 connecting the mobile phone 2 to the personal computer 4 and to distinguish when such link 66 has been detected.

Still referring to FIG. 1, the personal computer 4 of the system 1 includes a communication interface 26 which is adapted to set up the communication link between the mobile phone 2 and the personal computer 4. The personal computer 4 is generally made up of a central processing unit 28 with a memory 30.

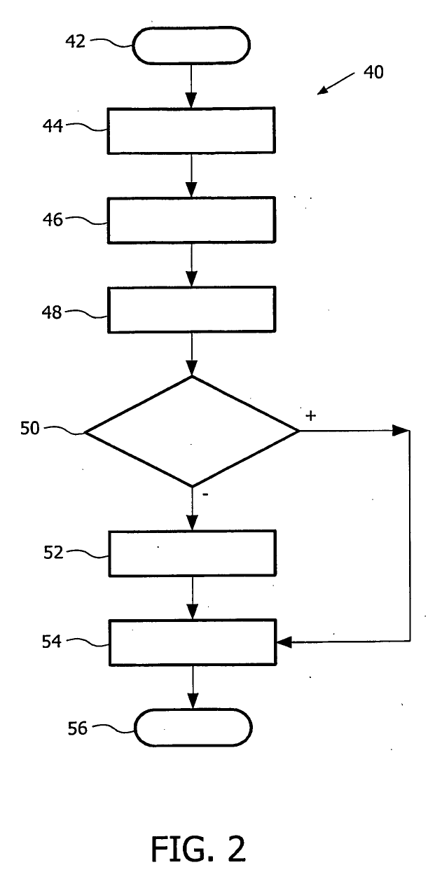

Referring now to FIG. 2, a method 40 for exchanging multimedia related data between the mobile phone 2 and the personal computer 4 is shown. From a starting step 42, the mobile phone 2 receives the MMS message 8 in a step 44. The MMS message 8 sent to the mobile phone 2 contains multimedia rich files, for example.

Subsequently, in a step 46, after the transmitter/receiver 10 of the mobile phone 2 receives the MMS message 8, the exchanging module 20 extracts a particular multimedia file element such as an image or an audio file from the MMS message 8. In other words, when, for example, the image file is extracted in the step 46, it is then exchanged between the mobile phone 2 and the personal computer 4.

Thereafter, in a step 48, the personal computer 4 detects the connection between the mobile phone 2 and the personal computer 4.

Next, in a step 50, after extracting the file, the controller 18 of the mobile phone 2 determines whether the extracted image file is compliant with the format required for data exchange with the personal computer 4.

Thus, in a step 52, if the extracted image file is not compliant with a required format such as EXIF, the file format changing module 22 changes the format of the image file to an EXIF format before the extracted image file is sent to the personal computer 4.

In a subsequent step 54, the extracted image file in the newly adapted EXIF format is sent directly to the personal computer 4 for further processing. This, in turn, ends method 40 of the mobile phone 2 in a final step 56.

On the other hand, if at step 50, the extracted multimedia file is already in the compliant format, the mobile phone 2 proceeds directly to step 54.

Moreover, if the MMS message 8 includes both image and sound data, image and sound files are extracted by the exchanging module 22 and adapted to be compliant with the EXIF format as well.

Additionally, applications in the mobile phone 2 also comply with a DPOF (Digital Print Order Format), a standard format for a direct print of images stored in devices such as digital cameras.

The detecting module 24 is adapted to recognise the physical data link 6 to the personal computer 4 and behaves as a digital camera by either action on the user's part through a manual interface in the mobile phone 2 or preferably a plug-in play supported feature. For instance, the mobile phone 2 implements specific classes of applications usually associated with digital camera applications, allowing an automatic detection of the plug-in of the mobile phone 2 by the personal computer 4.

Thanks to the invention, the mobile phone 2 is considered a digital camera by the personal computer 4, irrespective of whether the mobile phone 2 incorporates a digital camera.

In addition, the personal computer 4 can be any device that supports connection with the mobile phone 2 or a digital camera such as a printer, a scanner, or a data storage medium. The physical data link 6 is any type of physical link compatible with the device to be connected, such as a USB (Universal Serial Bus) cable.

Many additional embodiments are possible. For example, a digital camera may be modified to support the transmission of MMS messages of multimedia files such as an image file contained in the digital camera. In this case, the image and the audio data files are converted from EXIF formats to MMS messages and sent to other destination devices via wireless communication methods.

1. A telecommunication device configured to exchange multimedia related data through a data link between the telecommunication device and a destination device adapted to process the data, the telecommunication device comprising means for receiving multimedia messaging service (MMS) messages;
wherein the telecommunication device further comprises
an extracting module configured to extract an embedded multimedia element from a multimedia messaging service (MMS) message, the embedded multimedia element having a file format; and
a file format changer configured to change the file format of the embedded multimedia information into an adapted file format to be transmitted to the destination device.

2. The telecommunication device of claim 1, wherein the adapted file format is a file format in compliance with an Exchangeable Image File Format (EXIF).

3. The telecommunication device of claim 1, wherein the adapted file format is a file format in compliance with a Digital Print Order Format (DPOF).

4. The telecommunication device according to claim 1, wherein the telecommunication device is a mobile phone.

5. The telecommunication device according to claim 1, wherein the telecommunication device comprises a digital camera.

6. The telecommunication device according to claim 1, wherein the embedded multimedia element comprises data selected from the group consisting of image, video, and sound.

7. The telecommunication device according to claim 1, wherein the telecommunication device comprises a controller adapted to determine whether the extracted embedded multimedia element is compliant with data exchange with the destination device.

8. A system for exchanging multimedia related data, the system comprising: a telecommunication device according to any one of the preceding claims;
a destination device configured to transmit or receive the multimedia related data;
a data link configured to exchange the multimedia related data between the telecommunication device and the destination device.

9. The system according to claim 9, wherein the destination terminal is a printer device.

10. The system according to claim 9, wherein the destination terminal is a scanning device.

11. The system according to claim 9, wherein the data link comprises a wireless connection.

12. A method for exchanging multimedia related data in a telecommunication device according to claim 1, the method comprising:
extracting an embedded multimedia element comprising a file format from the MMS message;
determining whether the extracted embedded multimedia element is compliant for data exchange with the destination device;
changing the file format of the embedded multimedia element into an adapted file format to be transmitted to the destination device, wherein the changing of the file is carried out in a telecommunication device; and
transmitting the embedded multimedia element in the adapted file format between the telecommunication device and the destination terminal.

13. A computer-readable medium associated with a telecommunication device having a sequence of instructions stored thereon, which, when executed by a processor of the telecommunication device, causes the processor to:
extract an embedded multimedia element comprising a file format from a MMS message;
determine whether the extracted embedded multimedia element is compliant with data exchange with a destination device;
change the file format of the embedded multimedia element into an adapted file format to be transmitted to the destination device, wherein the changing of the file is carried out in the telecommunication device; and
transmit the embedded multimedia element in the adapted file format between the telecommunication device and the destination terminal.
